(19) United States
(12) Patent Application Publication
(10) Pub. No.: US 2026/0220565 A1
(43) Pub. Date: Jul. 30, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Takeshi AKAGAWA, Tokyo (JP); Satoshi ODA, Tokyo (JP); Hideki KOMORI, Tokyo (JP)

(73) Assignee: NEC Corporation, Tokyo (JP)

(21) Appl. No.: 19/146,606

(22) PCT Filed: Dec. 13, 2023
(86) PCT No.: PCT/JP2023/044591

§ 371 Date: Jul. 9, 2025

(30) Foreign Application Priority Data
Jan. 17, 2023 (JP) 2023-004995

(51) Int. Cl. G06Q 10/0631

(52) U.S. Cl. CPC G06Q 10/063112

(57) ABSTRACT

Provided are an information processing device, an information processing method, and a program which suitably connect an individual user and human resources sought by a company user. This information processing device comprises a skill information acquisition unit and a potential skill estimation unit. The skill information acquisition unit acquires skill information pertaining to a skill of an individual user. The potential skill estimation unit estimates, from the acquired skill information, potential skill information pertaining to a potential skill of the individual user by using a learning model that has been trained by taking, as teaching data for estimating the potential skill, skill information for training pertaining to the skill of the individual user.

### TECHNICAL FIELD

The present disclosure relates to an information processing device, an information processing method, and a program.

### BACKGROUND ART

There is a matching service that connects companies looking for new personnel from outside the organization and individuals looking for companies to hire them. A technology for connecting corporate users and individual users has been developed.

For example, there is disclosed a technology for calculating a mind value, which is an index for evaluating an individual's attitude toward engagement with an event, calculating a character value, which is an index for evaluating a disposition fixed and formed in an individual, and evaluating an individual's potential ability, from subject information input from a subject terminal.

### CITATION LIST

### Patent Literature

PTL 1: JP 2003-030316 A

### SUMMARY OF INVENTION

### Technical Problem

In a service that connects a corporate user and an individual user, it is required to introduce a large number of partners suitable for mutual needs to each of the corporate user and the individual user. However, the individual user does not register all of his/her skills in the job posting information. Therefore, although there is a possibility that mutual needs match, there may be a case where no introduction is made.

In view of the above problems, an object of the present disclosure is to provide an information processing device, an information processing method, and a program that suitably connect the personnel sought by a corporate user and an individual user.

### Solution to Problem

According to an aspect of the present disclosure, there is provided an information processing device including:
a skill information acquisition unit for acquiring skill information regarding a skill of an individual user; and
a potential skill estimation unit for estimating potential skill information regarding a potential skill of the individual user from the acquired skill information by using a trained machine learning model trained on training data for estimating the potential skill.

According to another aspect of the present disclosure, there is provided an information processing method including causing a computer to:
acquire skill information regarding a skill of an individual user; and
estimate potential skill information regarding a potential skill of the individual user from the acquired skill information by using a trained machine learning model trained on training data for estimating the potential skill.

According to still another aspect of the present disclosure, there is provided a program causing a computer to execute processing of:
acquiring skill information regarding a skill of an individual user; and
estimating potential skill information regarding a potential skill of the individual user from the acquired skill information by using a trained machine learning model trained on training data for estimating the potential skill.

### Advantageous Effects of Invention

According to the present disclosure, it is possible to provide an information processing device, an information processing method, and a program that suitably connect the personnel sought by a corporate user and an individual user.

### BRIEF DESCRIPTION OF DRAWINGS

FIG. 1 is a block diagram illustrating a configuration of an information processing device according to the present example embodiment.

FIG. 2 is a block diagram illustrating a configuration of an information processing device according to the present example embodiment.

FIG. 3 is a diagram illustrating processing of a potential skill estimation unit of an information processing device according to the present example embodiment.

FIG. 4 is a flowchart illustrating a notification operation of an information processing device according to the present example embodiment.

FIG. 5 is a flowchart illustrating a potential skill correction operation of an information processing device according to the present example embodiment.

FIG. 6 is a block diagram illustrating a configuration of an information processing device according to the present example embodiment.

FIG. 7 is a flowchart illustrating an example of a notification operation of an information processing device according to the present example embodiment.

FIG. 8 is a block diagram illustrating a configuration of a computer according to the present example embodiment.

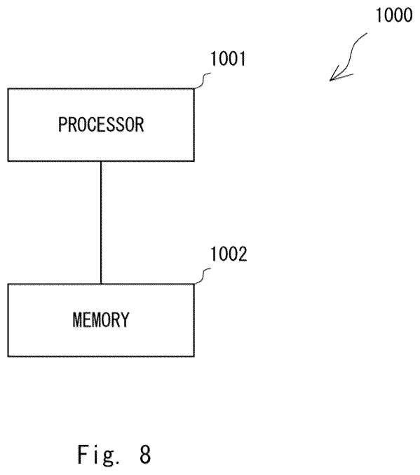

### EXAMPLE EMBODIMENT

Hereinafter, specific example embodiments to which the present disclosure is applied will be described in detail with reference to the drawings. In the drawings, the same or corresponding elements are denoted by the same reference numerals, and repeated description is omitted as necessary for clarity of description.

### First Example Embodiment

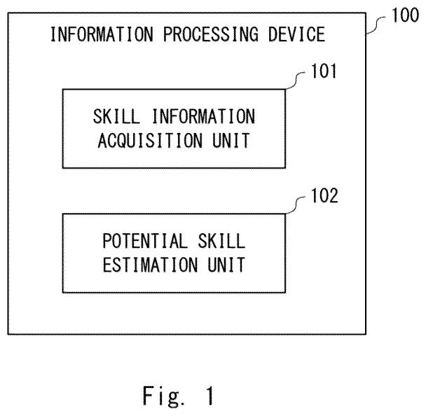

First, a configuration of an information processing device 100 according to a first example embodiment will be described with reference to FIG. 1.

FIG. 1 is a block diagram illustrating an example of the configuration of the information processing device 100 according to the present example embodiment.

The information processing device 100 includes a skill information acquisition unit 101 and a potential skill estimation unit 102. The skill information acquisition unit 101 acquires skill information regarding a skill of an individual user. The potential skill estimation unit 102 estimates, from the acquired skill information, potential skill information regarding a potential skill of an individual user by using a trained machine learning model trained on training data that is the potential skills of users for training.

Therefore, the information processing device 100 according to the first example embodiment can estimate the potential skill of the individual user. Thus, the present example embodiment can provide an information processing device that suitably connects the personnel sought by a corporate user and an individual user.

### Second Example Embodiment

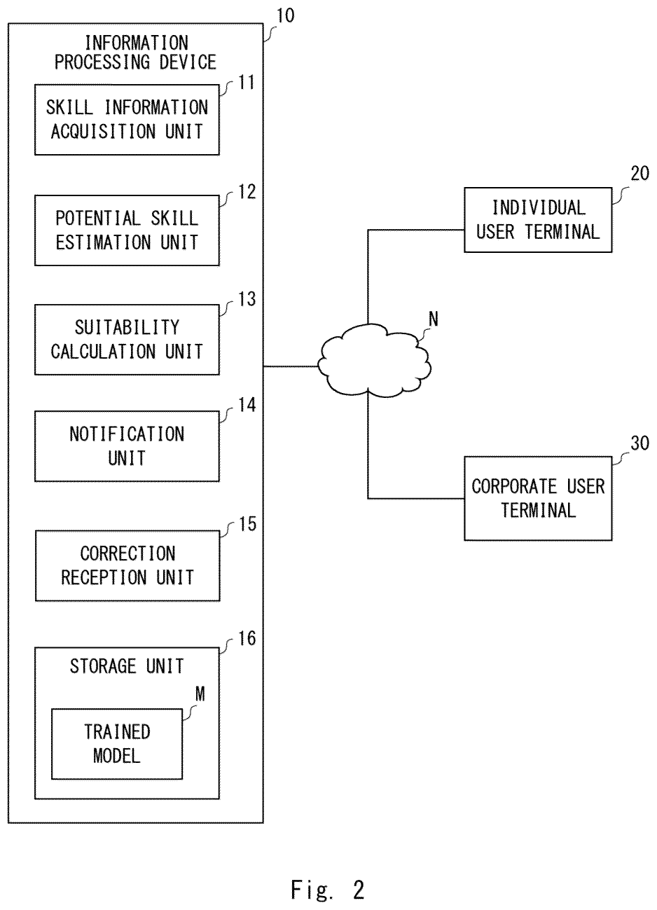

Subsequently, a configuration of an information processing device 10 according to a second example embodiment will be described with reference to FIG. 2.

FIG. 2 is a block diagram illustrating an example of the configuration of the information processing device 10 according to the present example embodiment. The information processing device 10 implements the information processing device 100 according to the first example embodiment. The information processing device 10 is, for example, a computer or a server. The information processing device 10 may be configured to be constructed on a cloud. The information processing device 10 is used for a matching service that connects the corporate user looking for new personnel from outside the organization and the individual user looking for companies to hire him/her. The information processing device 10 communicates with at least one individual user terminal 20 and at least one corporate user terminal 30 via a network N such as the Internet, and transmits and receives data. The individual user terminal 20 is a terminal such as a smartphone, a tablet, or a personal computer (PC) used by an individual user. The corporate user terminal 30 is a terminal such as a smartphone, a tablet, or a PC used by a corporate user.

The information processing device 10 mainly includes a skill information acquisition unit 11, a potential skill estimation unit 12, a suitability calculation unit 13, a notification unit 14, a correction reception unit 15, and a storage unit 16. The skill information acquisition unit 11 and the potential skill estimation unit 12 correspond to the skill information acquisition unit 101 and the potential skill estimation unit 102 of the information processing device 100, respectively.

The skill information acquisition unit 11 acquires skill information of an individual user. The skill information acquisition unit 11 acquires the skill information from the individual user terminal 20 or the storage unit 16. The skill information includes at least one skill (Skill #1,Skill #2,Skill #3, . . . Skill #N) actually possessed by the individual user.

The skill is, for example, an ability required when an individual user performs a predetermined job. More specifically, the skill includes an ability to operate a predetermined machine, an ability to communicate using a predetermined language, and an ability to execute a predetermined skill or action. The skill may include knowledge and job history information possessed by the individual user. The job history information is information indicating a job experienced by the individual user, and may include an industry type, a job category, and a period of experience. The job history information includes the skill information, and thus the information processing device 10 can perform weighting by using, for example, the job history when calculating the suitability. Thus, the information processing device 10 can more suitably connect the corporate user and the individual user. The skill information acquisition unit 11 may acquire the skill information from the storage unit 16.

By using a trained model M stored in the storage unit 16, the potential skill estimation unit 12 estimates the potential skill information, which is a skill potentially possessed by the individual user, from the skill information received from the individual user terminal 20. More specifically, the potential skill estimation unit 12 inputs the received skill information of the individual user to the trained model M, and receives the potential skill information as an output for the input.

The potential skill information includes at least one potential skill (Potential skill #1, Potential skill #2, Potential skill #3, . . . Potential skill #N) potentially possessed by the individual user. The potential skill is a skill highly related to the skill information of the individual user. Specifically, for example, the potential skill in a case where skill information regarding the ability to use Architectural CAD is received includes the use of structural engineering software highly related to the Architectural CAD. The trained model M includes the reliability of the potential skill to be estimated in the potential skill information for such skill information. The reliability of the potential skill is an index indicating the possibility that the individual user actually has the potential skill to be estimated. The potential skill estimation unit 12 may determine skill information mainly used for estimating the potential skill information. The potential skill estimation unit 12 stores, in the storage unit 16, the potential skill information and the skill information mainly used for estimating the potential skill information.

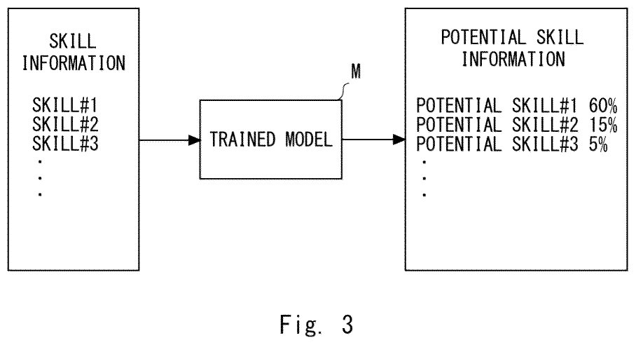

FIG. 3 is a diagram specifically illustrating an example of the function of the potential skill estimation unit 12 of the information processing device 10 according to the present example embodiment. As illustrated in FIG. 3, the potential skill estimation unit 12 inputs the skill information (Skill #1, Skill #2, Skill #3, . . . ) to the trained model M and estimates the potential skill information (Potential skill #1: 60%, Potential skill #2: 15%, Potential skill #3: 5%, . . . ).

More specifically, for example, the potential skill estimation unit 12 inputs, as the skill information, information regarding the ability to use Architectural CAD, information regarding the ability to use word processing software, roles of a leader, a sub-leader, and the like, and years of experience, to the trained model M. Through the trained model M, the potential skill estimation unit 12 estimates, as the potential skill information, that the possibility of being able to use semiconductor CAD is 60%, the possibility of being able to use AutoCAD is 15%, and the possibility of being able to use civil engineering CAD is 5%. The potential skill estimation unit 12 determines which skill in the information skill is mainly used for estimating the potential skill information. In the above-described example, the potential skill estimation unit 12 determines that the skill in the Architectural CAD is mainly used for estimating the potential skill in the semiconductor CAD, the AutoCAD, the civil engineering CAD, or the like.

The suitability calculation unit 13 calculates the suitability between the individual user and the corporate user by collating at least one of the skill information or the potential skill information with the required skill information indicating the skill that a corporate user requires of an individual user. For example, the suitability is represented by a numerical value indicating how well at least one of the skill information or the potential skill information satisfies the required skill information required by the corporate user. The suitability calculation unit 13 can set the suitability based on the possibility of having the potential skill included in the potential skill information. The suitability calculation unit 13 stores the suitability in the storage unit 16.

The notification unit 14 notifies at least one of the individual user terminal 20 used by the individual user or the corporate user terminal 30 used by the corporate user of the collation result based on the suitability. Specifically, in a case where the suitability is equal to or more than a predetermined threshold, the notification unit 14 notifies at least one of the individual user terminal 20 or the corporate user terminal 30 of the skill information, the potential skill information, the required skill information, and the suitability.

The notification unit 14 notifies the individual user terminal 20 of the skill information mainly used for estimating the potential skill information determined by the potential skill estimation unit 12.

The correction reception unit 15 presents the potential skill information stored in the storage unit 16 to the individual user terminal 20, and receives the correction of the potential skill information stored in the storage unit 16 from the individual user terminal 20.

The storage unit 16 stores the trained model M. The trained model M is a model for machine learning or deep learning. The trained model M is trained by a training device (not illustrated) using the skill information regarding the skill of the individual user for training as training data for estimating the potential skill. The skill information regarding the skill of the individual user for training includes a plurality of skills possessed by the individual user. The training device trains the trained model M on the relationships of a plurality of these skills. Thus, in a case where the skill information of an optional individual user is received as an input, the trained model M can estimate a highly related potential skill from the received skill information. The storage unit 16 stores the skill information, the potential skill information, the required skill information, and the suitability.

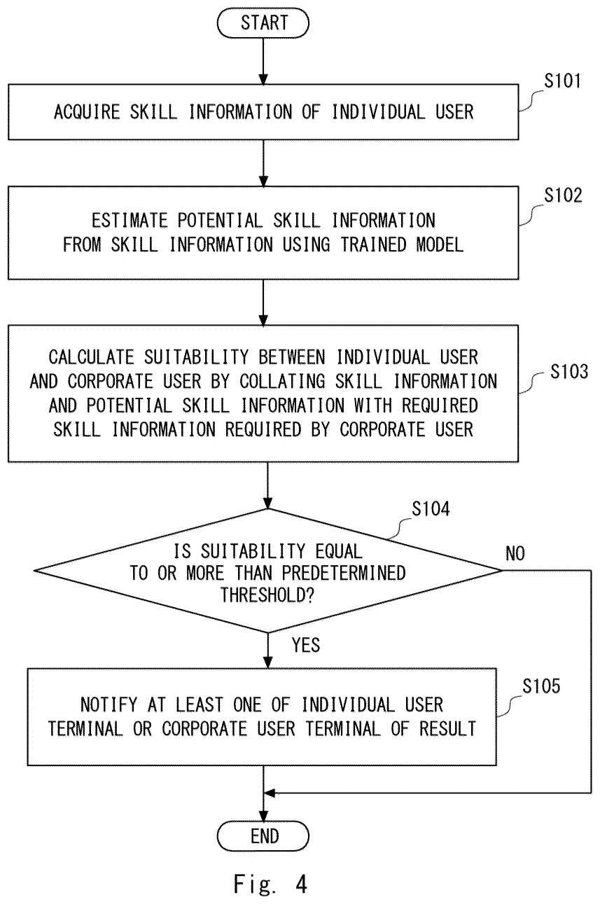

Subsequently, the notification operation of the information processing device 10 according to the second example embodiment will be described with reference to FIG. 4.

FIG. 4 is a flowchart illustrating an example of the notification operation of the information processing device 10 according to the present example embodiment.

First, the skill information acquisition unit 11 of the information processing device 10 acquires skill information of an individual user (step S101). The skill information acquisition unit 11 acquires the skill information from the individual user terminal 20 or the storage unit 16.

Next, the potential skill estimation unit 12 estimates the potential skill information from the skill information using the trained model M stored in the storage unit 16 (step S102). The potential skill estimation unit 12 determines the skill information mainly used for estimating the potential skill information. The potential skill estimation unit 12 stores, in the storage unit 16, the potential skill information and the skill information mainly used for estimating the potential skill information.

Next, the suitability calculation unit 13 calculates the suitability between the individual user and the corporate user by collating at least one of the skill information or the potential skill information with the required skill information indicating the skill that the corporate user requires of the individual user (step S103). The suitability calculation unit 13 stores the suitability in the storage unit 16.

Next, the notification unit 14 determines whether the suitability is equal to or more than a predetermined threshold (step S104). In a case where it is determined that the suitability is equal to or more than the predetermined threshold (YES in step S104), the notification unit 14 notifies at least one of the individual user terminal 20 or the corporate user terminal 30 of the result (step S105). Specifically, the notification unit 14 notifies at least one of the individual user terminal 20 or the corporate user terminal 30 of the skill information, the potential skill information, the required skill information, and the suitability. The notification unit 14 notifies the individual user terminal 20 of the skill information mainly used for estimating the potential skill information determined by the potential skill estimation unit 12. On the other hand, in a case where it is determined that the suitability is not equal to or more than the predetermined threshold (NO in step S104), the notification unit 14 ends the processing.

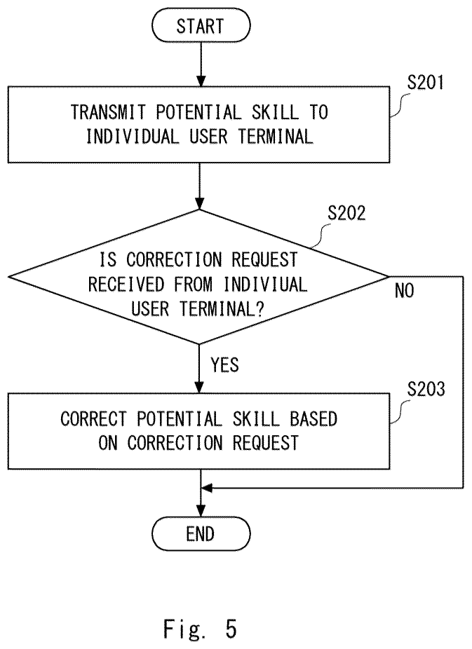

Subsequently, the potential skill correction operation of the information processing device 10 according to the second example embodiment will be described with reference to FIG. 5.

FIG. 5 is a flowchart illustrating an example of the potential skill correction operation of the information processing device 10 according to the present example embodiment.

First, the correction reception unit 15 of the information processing device 10 transmits the potential skill information stored in the storage unit 16 to the individual user terminal 20 of the individual user (step S201). Next, the correction reception unit 15 determines whether a correction request for the potential skill information is received from the individual user terminal 20 (step S202). In a case where it is determined that the correction request for the potential skill information is received from the individual user terminal 20 (YES in step S202), the correction reception unit 15 corrects the stored potential skill information in accordance with the correction request. On the other hand, in a case where it is determined that the correction request for the potential skill information is not received from the individual user terminal 20 (NO in step S202), the correction reception unit 15 ends the processing.

As described above, the information processing device 10 according to the second example embodiment can estimate the potential skill information of the individual user from the skill information of the individual user by using the trained machine learning model. Therefore, the information processing device can determine a corporate user who potentially matches an individual user's needs. The information processing device 10 can determine an individual user who potentially matches the corporate user's needs. For example, there is a widespread shortage of engineers. In the matching service between the corporate user and the individual user, by estimating the potential skill of the individual user, it is possible to identify an individual who is suited to be the engineer even when the individual is not an engineer at present. It can be expected to solve the engineer shortage.

By estimating the potential skill, the information processing device 10 enables the corporate user or the individual user to identify a skill that an individual user can acquire in a short period of time. The corporate user can reduce the cost of the training or the like.

By calculating the suitability, the information processing device 10 can introduce a corporate user with a high suitability for the individual user and introduce an individual user with a high suitability for the corporate user.

Although the second example embodiment has been described above, the information processing device according to the present example embodiment is not limited to the above-described configuration. For example, the information processing device 10 may not include the trained model M. In this case, the information processing device 10 may be communicably connected to a predetermined external terminal including the trained model M and communicate with the external terminal to implement the above-described function.

With the configuration described above, the present example embodiment can provide an information processing device that suitably connects the personnel sought by the corporate user and the individual user. The information processing device 10 can more suitably connect the corporate user and the individual user by receiving the correction of the potential skill information from the individual user.

### Third Example Embodiment

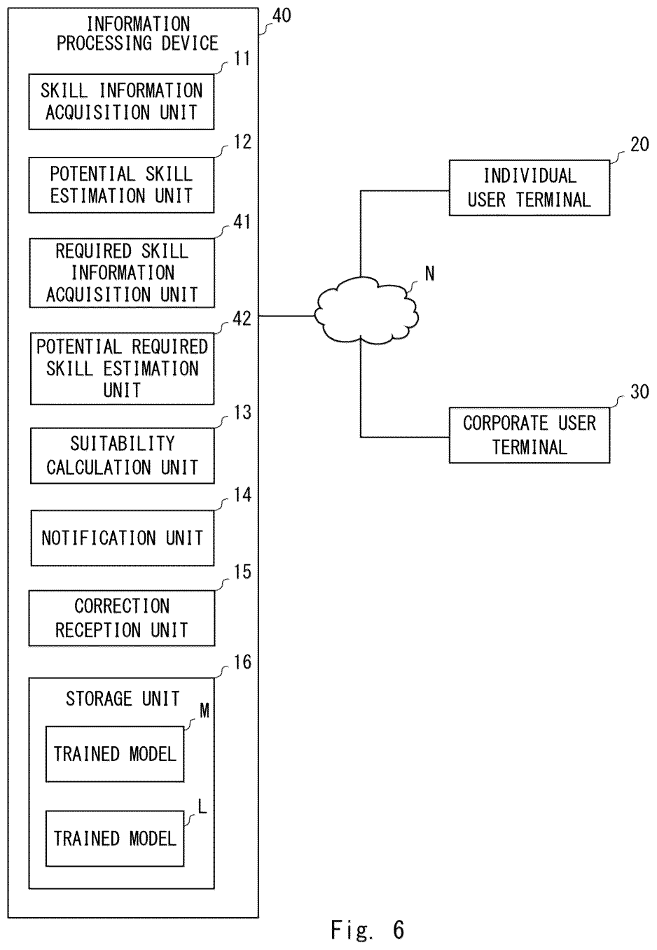

Subsequently, a configuration of an information processing device 40 according to a third example embodiment will be described with reference to FIG. 6.

FIG. 6 is a block diagram illustrating an example of the configuration of the information processing device 40 according to the present example embodiment. The information processing device 40 is obtained by adding a required skill information acquisition unit 41 and a potential required skill estimation unit 42 to the configuration of the information processing device 10 according to the second example embodiment. The suitability calculation unit 13 and the storage unit 16 have the following functions added.

The required skill information acquisition unit 41 acquires required skill information (Required skill #1, Required skill #2, Required skill #3, . . . , Required skill #N) indicating a skill that the corporate user requires of the individual user.

By using a trained model L stored in the storage unit 16, the potential required skill estimation unit 42 estimates, from the acquired required skill information, the potential required skill information regarding a skill that the corporate user potentially requires of the individual user. The potential required skill information includes at least one potential required skill (Potential required skill #1, Potential required skill #2, Potential required skill #3, . . . Potential required skill #N) that the corporate user potentially requires of the individual user. In a case where the required skill information indicates, for example, a C-language skill and programmer experience in the automobile industry, the potential required skill estimation unit 42 estimates the embedded C-language skill as the potential required skill information. The trained model L is a model for machine learning or deep learning. The trained model L is trained by a training device (not illustrated) using the required skill information for training as training data for estimating the potential required skill information.

The suitability calculation unit 13 calculates the suitability between the individual user and the corporate user by collating at least one of the skill information or the potential skill information with at least one of the required skill information or the potential required skill information.

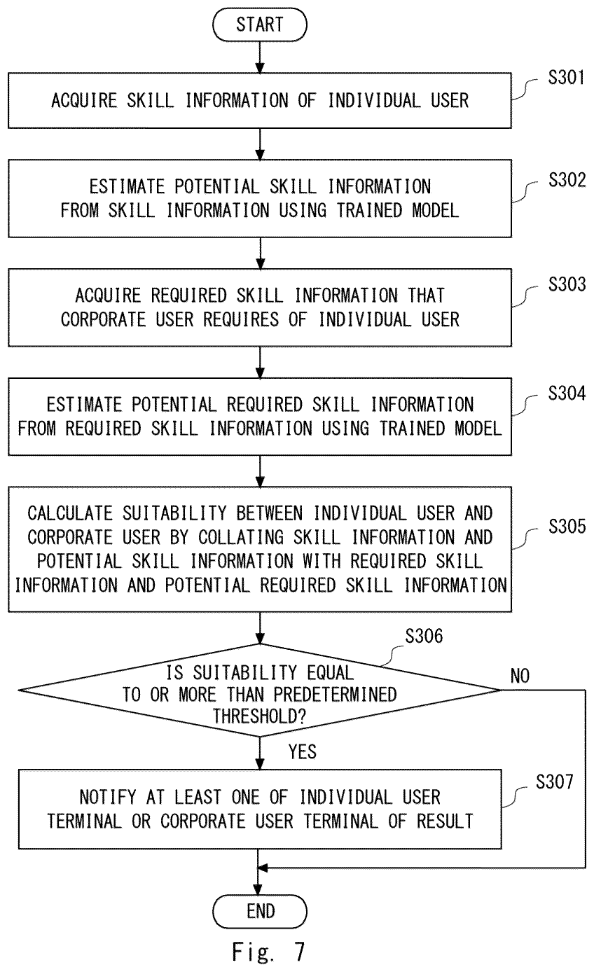

Subsequently, the notification operation of the information processing device 40 according to the third example embodiment will be described with reference to FIG. 7.

FIG. 7 is a flowchart illustrating an example of the notification operation of the information processing device 40 according to the present example embodiment.

First, the skill information acquisition unit 11 of the information processing device 40 acquires skill information of an individual user (step S301). The skill information acquisition unit 11 acquires the skill information from the individual user terminal 20 or the storage unit 16.

Next, the potential skill estimation unit 12 estimates the potential skill information from the skill information using the trained model M stored in the storage unit 16 (step S302). The potential skill estimation unit 12 determines the skill information mainly used for estimating the potential skill information. The potential skill estimation unit 12 stores, in the storage unit 16, the potential skill information and the skill information mainly used for estimating the potential skill information.

Next, the required skill information acquisition unit 41 acquires required skill information indicating a skill that the corporate user requires of the individual user (step S303). The required skill information acquisition unit 41 acquires the required skill information from the corporate user terminal 30 or the storage unit 16.

Next, by using the trained model L stored in the storage unit 16, the potential required skill estimation unit 42 estimates, from the acquired required skill information, the potential required skill information regarding the skill that the corporate user potentially requires of the individual user (step S304). The potential required skill estimation unit 42 determines the required skill information mainly used for estimating the potential required skill information. The potential required skill estimation unit 42 stores, in the storage unit 16, the potential required skill information and the required skill information mainly used for estimating the potential required skill information.

Next, the suitability calculation unit 13 calculates the suitability between the individual user and the corporate user by collating at least one of the skill information or the potential skill information with at least one of the required skill information and the potential required skill information (step S305). The suitability calculation unit 13 stores the suitability in the storage unit 16.

Next, the notification unit 14 determines whether the suitability is equal to or more than a predetermined threshold (step S306). In a case where it is determined that the suitability is equal to or more than the predetermined threshold (YES in step S306), the notification unit 14 notifies at least one of the individual user terminal 20 or the corporate user terminal 30 of the result (step S307). Specifically, the notification unit 14 notifies at least one of the individual user terminal 20 or the corporate user terminal 30 of the skill information, the potential skill information, the required skill information, and the suitability. The notification unit 14 notifies at least one of the individual user terminal 20 or the corporate user terminal 30 of the skill information mainly used for estimating the potential skill information determined by the potential skill estimation unit 12. The notification unit 14 may notify at least one of the individual user terminal 20 or the corporate user terminal 30 of the required skill information mainly used for estimating the potential required skill information. On the other hand, in a case where it is determined that the suitability is not equal to or more than the predetermined threshold (NO in step S306), the notification unit 14 ends the processing.

As described above, the information processing device 40 according to the third example embodiment estimates the potential required skill information from the required skill information by using the trained machine learning model. The information processing device 40 calculates the suitability between the individual user and the corporate user by using the potential required skill information. Therefore, the information processing device 40 can more suitably connect the personnel sought by the corporate user and the individual user in consideration of the potential needs of the company.

Each configuration in the above-described example embodiments may be implemented by hardware, software, or both, and may be implemented by one piece of hardware or software or by a plurality of pieces of hardware or software. The devices and functions (processing) may be implemented by a computer 1000 including a processor 1001 such as a central processing unit (CPU), and a memory 1002 which is a storage device, as illustrated in FIG. 6. For example, a program that performs the method (image processing method) in the example embodiment may be stored in the memory 1002, and each function may be implemented by the processor 1001 by executing the program stored in the memory 1002.

These programs include a group of instructions (or software codes) causing a computer to perform one or more of the functions described in the example embodiments in a case of being read by the computer. The program may be stored in a non-transitory computer readable medium or a tangible storage medium. As an example and not by way of limitation, the computer-readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer-readable medium or a communication medium. As an example and not by way of limitation, the transitory computer-readable medium or the communication medium includes propagated signals in electrical, optical, acoustic, or other forms.

The present disclosure is not limited to the above-described example embodiments, and can be appropriately modified without departing from the scope.

Some or all of the above-described example embodiments may be described as the following supplementary notes, but are not limited to the following supplementary notes.

### (Supplementary Note 1)

An information processing device including:
a skill information acquisition unit for acquiring skill information regarding a skill of an individual user; and
a potential skill estimation unit for estimating potential skill information regarding a potential skill of the individual user from the acquired skill information by using a trained machine learning model trained on training data for estimating the potential skill.

### (Supplementary Note 2)

The information processing device according to Supplementary note 1, in which the skill information includes job history information indicating a job history of the individual user.

### (Supplementary Note 3)

The information processing device according to Supplementary note 1, further including a suitability calculation unit for calculating suitability between the individual user and a corporate user by collating the skill information and the potential skill information with required skill information that the corporate user requires of the individual user.

### (Supplementary Note 4)

The information processing device according to Supplementary note 3, further including a notification unit for notifying at least one of the individual user or the corporate user of a result of the collation based on the suitability.

### (Supplementary Note 5)

The information processing device according to Supplementary note 4, in which
the potential skill estimation unit
determines the skill information mainly used for estimating the potential skill information, and
the notification unit
notifies the individual user of the skill information mainly used for estimating the determined potential skill information.

### (Supplementary Note 6)

The information processing device according to Supplementary note 1, further including:
a required skill information acquisition unit for acquiring required skill information that a corporate user requires of the individual user; and
a potential required skill estimation unit for estimating, from the acquired required skill information, potential required skill information regarding a skill that the corporate user potentially requires of the individual user by using a trained machine learning model trained using required skill information for training as training data.

### (Supplementary Note 7)

The information processing device according to Supplementary note 6, further including a suitability calculation unit for calculating suitability between the individual user and the corporate user by collating the skill information and the potential skill information with the required skill information and the potential required skill information.

### (Supplementary Note 8)

The information processing device according to Supplementary note 7, further including a notification unit for notifying at least one of the individual user or the corporate user of a result of the collation based on the suitability.

### (Supplementary Note 9)

The information processing device according to Supplementary note 1, further including a correction reception unit for presenting the potential skill information to the individual user and receiving correction of the potential skill information from the individual user.

### (Supplementary Note 10)

An information processing method including causing a computer to:
acquire skill information regarding a skill of an individual user; and
estimate potential skill information regarding a potential skill of the individual user from the acquired skill information by using a trained machine learning model trained on training data for estimating the potential skill.

### (Supplementary Note 11)

The information processing method according to Supplementary note 10, in which the skill information includes job history information indicating a job history of the individual user.

### (Supplementary Note 12)

The information processing method according to Supplementary note 10, further including causing the computer to calculate suitability between the individual user and a corporate user by collating the skill information and the potential skill information with required skill information that the corporate user requires of the individual user.

### (Supplementary Note 13)

The information processing method according to Supplementary note 12, further including causing the computer to notify at least one of the individual user or the corporate user of a result of the collation based on the suitability.

### (Supplementary Note 14)

The information processing method according to Supplementary note 13, further including causing the computer to:
determine the skill information mainly used for estimating the potential skill information; and
notify the individual user of the skill information mainly used for estimating the determined potential skill information.

### (Supplementary Note 15)

The information processing method according to Supplementary note 10, further including causing the computer to:
acquire required skill information that a corporate user requires of the individual user; and
estimate, from the acquired required skill information, potential required skill information regarding a skill that the corporate user potentially requires of the individual user by using a trained machine learning model trained using required skill information for training as training data.

### (Supplementary Note 16)

The information processing method according to Supplementary note 15, further including causing the computer to calculate suitability between the individual user and the corporate user by collating the skill information and the potential skill information with the required skill information and the potential required skill information.

### (Supplementary Note 17)

The information processing method according to Supplementary note 16, further including causing the computer to notify at least one of the individual user or the corporate user of a result of the collation based on the suitability.

### (Supplementary Note 18)

The information processing method according to Supplementary note 10, further including causing the computer to present the potential skill information to the individual user and receive correction of the potential skill information from the individual user.

### (Supplementary Note 19)

A program causing a computer to execute processing of:
acquiring skill information regarding a skill of an individual user; and
estimating potential skill information regarding a potential skill of the individual user from the acquired skill information by using a trained machine learning model trained on training data for estimating the potential skill.

### (Supplementary Note 20)

The program according to Supplementary note 19, in which the skill information includes job history information indicating a job history of the individual user.

### (Supplementary Note 21)

The program according to Supplementary note 19, further causing the computer to execute processing of calculating suitability between the individual user and a corporate user by collating the skill information and the potential skill information with required skill information that the corporate user requires of the individual user.

### (Supplementary Note 22)

The program according to Supplementary note 21, further causing the computer to execute processing of notifying at least one of the individual user or the corporate user of a result of the collation based on the suitability.

### (Supplementary Note 23)

The program according to Supplementary note 22, further causing the computer to execute processing of:
determining the skill information mainly used for estimating the potential skill information; and
notifying the individual user of the skill information mainly used for estimating the determined potential skill information.

### (Supplementary Note 24)

The program according to Supplementary note 19, further causing the computer to execute processing of:
acquiring required skill information that a corporate user requires of the individual user; and
estimating, from the acquired required skill information, potential required skill information regarding a skill that the corporate user potentially requires of the individual user by using a trained machine learning model trained using required skill information for training as training data.

### (Supplementary Note 25)

The program according to Supplementary note 24, further causing the computer to execute processing of calculating suitability between the individual user and the corporate user by collating the skill information and the potential skill information with the required skill information and the potential required skill information.

### (Supplementary Note 26)

The program according to Supplementary note 25, further causing the computer to execute processing of notifying at least one of the individual user or the corporate user of a result of the collation based on the suitability.

### (Supplementary Note 27)

The program according to Supplementary note 19, further causing the computer to execute processing of presenting the potential skill information to the individual user and receiving correction of the potential skill information from the individual user.

While the invention of the present application has been particularly shown and described with reference to the example embodiments, the invention of the present application is not limited to these example embodiments. It will be understood by those of ordinary skill in the art that various changes in form and details may be made therein without departing from the spirit and scope of the invention of the present application within the scope of the invention as defined by the claims.

This application is based upon and claims the benefit of priority from Japanese patent application No. 2023 004995, filed on Jan. 17, 2023, the disclosure of which is incorporated herein in its entirety by reference.

### REFERENCE SIGNS LIST

10, 40, 100 information processing device
11 skill information acquisition unit
12 potential skill estimation unit
13 suitability calculation unit
14 notification unit
15 correction reception unit
16 storage unit
20 individual user terminal
30 corporate user terminal
41 required skill information acquisition unit
42 potential required skill estimation unit
101 skill information acquisition unit
102 potential skill estimation unit
1000 computer
1001 processor
1002 memory

What is claimed is:

1. An information processing device comprising:
at least one memory configured to store instructions; and
at least one processor configured to execute the instructions to:
acquire skill information regarding a skill of an individual user; and
estimate potential skill information regarding a potential skill of the individual user from the acquired skill information by using a trained machine learning model trained on training data for estimating the potential skill.

2. The information processing device according to claim 1, wherein the skill information includes job history information indicating a job history of the individual user.

3. The information processing device according to claim 1, wherein the at least one processor configured to execute the instructions to calculate suitability between the individual user and a corporate user by collating the skill information and the potential skill information with required skill information that the corporate user requires of the individual user.

4. The information processing device according to claim 3, wherein the at least one processor configured to execute the instructions to notify at least one of the individual user or the corporate user of a result of the collation based on the suitability.

5. The information processing device according to claim 4, wherein
the at least one processor configured to execute the instructions to:
determine the skill information mainly used for estimating the potential skill information; and
notify the individual user of the skill information mainly used for estimating the determined potential skill information.

6. The information processing device according to claim 1, wherein the at least one processor configured to execute the instructions to:
acquire required skill information that a corporate user requires of the individual user; and
estimate, from the acquired required skill information, potential required skill information regarding a skill that the corporate user potentially requires of the individual user by using a trained machine learning model trained using required skill information for training as training data.

7. The information processing device according to claim 6, wherein the at least one processor configured to execute the instructions to calculate suitability between the individual user and the corporate user by collating the skill information and the potential skill information with the required skill information and the potential required skill information.

8. The information processing device according to claim 7, wherein the at least one processor configured to execute the instructions to notify at least one of the individual user or the corporate user of a result of the collation based on the suitability.

9. The information processing device according to claim 1, wherein the at least one processor configured to execute the instructions to present the potential skill information to the individual user and receive correction of the potential skill information from the individual user.

10. An information processing method comprising causing a computer to:
acquire skill information regarding a skill of an individual user; and
estimate potential skill information regarding a potential skill of the individual user from the acquired skill information by using a trained machine learning model trained on training data for estimating the potential skill.

11. The information processing method according to claim 10, wherein the skill information includes job history information indicating a job history of the individual user.

12. The information processing method according to claim 10, further comprising causing the computer to calculate suitability between the individual user and a corporate user by collating the skill information and the potential skill information with required skill information that the corporate user requires of the individual user.

13. The information processing method according to claim 12, further comprising causing the computer to notify at least one of the individual user or the corporate user of a result of the collation based on the suitability.

14. The information processing method according to claim 13, further comprising causing the computer to:
determine the skill information mainly used for estimating the potential skill information; and
notify the individual user of the skill information mainly used for estimating the determined potential skill information.

15. The information processing method according to claim 10, further comprising causing the computer to:
acquire required skill information that a corporate user requires of the individual user; and
estimate, from the acquired required skill information, potential required skill information regarding a skill that the corporate user potentially requires of the individual user by using a trained machine learning model trained using required skill information for training as training data.

16. The information processing method according to claim 15, further comprising causing the computer to calculate suitability between the individual user and the corporate user by collating the skill information and the potential skill information with the required skill information and the potential required skill information.

17. The information processing method according to claim 16, further comprising causing the computer to notify at least one of the individual user or the corporate user of a result of the collation based on the suitability.

18. The information processing method according to claim 10, further comprising causing the computer to present the potential skill information to the individual user and receive correction of the potential skill information from the individual user.

19. A non-transitory computer-readable medium storing a program causing a computer to execute processing of:
acquiring skill information regarding a skill of an individual user; and
estimating potential skill information regarding a potential skill of the individual user from the acquired skill information by using a trained machine learning model trained on training data for estimating the potential skill.

20. The non-transitory computer-readable medium storing according to claim 19, wherein the skill information includes job history information indicating a job history of the individual user.
